(19) United States
(12) Patent Application Publication
(10) Pub. No.: US 2002/0172762 A1
(43) Pub. Date: Nov. 21, 2002

(54) Multi-stage process for the production of gas-filled microcapsules with defined narrow size distribution by defined external gassing during the build-up of microcapsules

(75) Inventors: Wolfgang Schmidt, Berlin (DE); Andreas Briel, Berlin (DE); Georg Roessling, Glienicke (DE); Peter Hauff, Berlin (DE); Michael Reinhardt, Berlin (DE); Frank-Detlef Scholle, Velten (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Schering AG, Berlin (DE)

(21) Appl. No.: 10/022,844

(22) Filed: Dec. 20, 2001

(30) Foreign Application Priority Data
Dec. 21, 2000 (DE) 10065068.6

(51) Int. Cl. B01J 13/02

(52) U.S. Cl. 427/213.3

(57) ABSTRACT

The subject of the invention is a multi-stage process for the production of narrowly-distributed gas-filled microcapsules. In one process step, polymerization of the shell-shaping substance(s) takes place, and in a process step that is separated from it in space and/or time, the formation of the microcapsules by a build-up process takes place. The build-up process is carried out by low-energy defined gas input of the gas that is to be encapsulated with the aid of a porous membrane that has small defined pore openings.

The invention relates to a multi-stage process for the production of gas-filled microcapsules with defined narrow size distribution by defined external gassing during the build-up of microcapsules. The process steps of polymerization of the shell-shaping substance(s) and the build-up of microcapsules are carried out in each case while being stirred, but separately in time and/or space. The gas-filled microcapsules that are produced with the process according to the invention have a core-shell structure and are distinguished by a defined narrow size distribution. Based on their properties, they can be used for ultrasound as contrast media that can pass capillaries.

The application is based on the following definitions:

A microparticle is a structure-independent generic term for all particles with a particle diameter of greater than 500 nm.

A microcapsule is a microparticle that consists of a core and a solid shell.

Gas-filled microcapsules are microcapsules whose core contains gas.

Nanoparticle is a particle with a particle diameter of less than 500 nm.

Ultrasonic contrast medium is a preparation for use in ultrasonic diagnosis and/or ultrasonic therapy.

Population of gas-filled microcapsules is the total quantity of all gas-filled microcapsules in an ultrasonic contrast medium.

Stirring is the mixing of a liquid with a liquid, solid or gaseous substance in such a way that essentially no self-gassing of the medium is carried out, and from the latter, a gas-phase portion (Φ_{G}) of <1% results.

Dispersing is the mixing of a liquid with a liquid, solid or gaseous substance in such a way that a self-gassing of the medium is carried out, and from the latter, a gas-phase portion (Φ_{G}) of >1%, preferably >10%, results.

Dispersion is a colloidal (nanoparticle size<500 nm) or coarsely dispersed (microparticle size >500 nm) multi-phase system.

Primary dispersion is a colloidal dispersion that consists of nanoparticles, produced by polymerization of one or more monomers.

Microcapsule dispersion is a dispersion of gas-filled microcapsules.

Self-gassing is the input of gas into a liquid by the movement of the gas or by the production of a dynamic flow underpressure.

External gassing is the undefined active input of gas into a liquid.

Defined external gassing is an external gassing via a gas feed unit that generates gas bubbles with a defined narrow size distribution.

Flotation is the movement of gas-filled microcapsules directed against the acceleration force (acceleration due to gravity g, radial acceleration a) based on a difference in density between gas-filled microcapsules and dispersing agents.

Floated material is the creamed layer of gas-filled microcapsules after flotation.

Homopolymer: Polymer that consists of a monomer.

Copolymer: Polymer that consists of various monomers.

Polymer: Homopolymer or copolymer.

Shell-shaping substance(s): Monomer(s) from which polymer particles of the primary dispersion are obtained by polymerization.

In the case of echocardiography (also: cardiac sonography), conclusions can be drawn on morphology and sequences of movements of cardiac valves as well as the direction, rate and quality of the circulation. In this process of diagnosis, the procedure is done with ultrasound, whose interactions are shown color-coded (Doppler process). Because of their complication-free, simple application, ultrasonic diagnosis has found wide use in medicine.

The quality of the results is considerably improved by the use of contrast media.

As contrast media, substances that contain or release gases are used in medical ultrasonic diagnosis as a rule, since a more efficient density and thus impedance difference than between liquids or solids and blood can be produced with them.

The observation of cardiac echo effects with solutions that contain finely dispersed gas bubbles have been known in the literature for a long time. Since these unstabilized gas bubbles have only a very short service life, solutions that are produced in this way are unsuitable as contrast media for medical ultrasonic diagnosis.

In U.S. Pat. No. 4,276,885, a process for the production of gas bubbles, which are protected by a gelatin membrane before running together, is described. These microbubbles are preferably produced by an injection of the desired gas into a substance that can gel (for example gelatin) using a capillary. Storage of these microbubbles is possible only at low temperatures, whereby the latter are to be brought to body temperature again before in-vivo use. Heat-sterilization is excluded in principle, since in this case the microbubbles are destroyed just as in sterile filtration.

In European Patent EP 0 052 575 B1, ultrasonic contrast media that are based on physiologically well-tolerated solid aggregates that release gas bubbles into the blood stream after administration are described. The released gas bubbles are not stabilized and do not survive passage through the lungs, so that after intravenous administration, only a contrasting of the right half of the heart is possible.

In Patents EP 0 122 624 and EP 0 123 235, ultrasonic contrast media that consist of microparticles and gas bubbles are described. In contrast to EP 0 052 575 B1, a stabilization of the gas bubbles is carried out by means of a surface-active substance. Passage through the lungs is possible, so that these contrast media allow a contrasting of the entire vascular volume.

Both production processes are very expensive, however.

According to European Patent EP 0 324 938 B1, encapsulated microbubbles can be produced by microbubbles being produced by ultrasound in a protein solution, which are subsequently stabilized in that because of a local temperature increase, the protein is partially denatured and encloses the gas bubbles.

The proposed use of human serum albumin (HSA) involves a considerable allergenic risk, however.

In European Patent EP 0 398 935 B1, microparticles whose shell substance consists of synthetic, biodegradable polymer material are described as ultrasonic contrast media. As a shell substance, in this case, a whole series of polymers are suitable, which are dissolved in a water-immiscible solvent or solvent mixture and are emulsified in water after possible addition of other solvents. As solvents, accordingly, furan, pentane and acetone can be used, among others.

In a process variant, the monomer that is dissolved in one of the above-mentioned solvents is polymerized in an aqueous solution that contains gas bubbles.

In all processes that are mentioned in the claims, the obligatory use of an organic solvent is of considerable disadvantage, since the latter has to be removed completely during the course of the production process.

With the techniques that are disclosed in European Patent EP 0 458 745, gas-filled microballoons can be produced in a wide range of sizes. To this end, first a solution of the shaping polymer is emulsified in an organic solvent in water and then diluted, by which the finely dispersed polymer solution drops are solidified. The enclosed solvent must be removed in an additional step, which is an expensive process. It is advantageous in this process that there is a direct possible way of influencing the size of the microcapsules that are produced by the selection of the surfactant or the rpm. In this case, however, different forms of administration, such as intravenous injection, which requires in particular small particles for passing through the lungs, as well as oral administration with correspondingly larger particles, are to be covered by the process. A solvent-free synthesis of gas-filled microparticles is also not possible in this way, however.

A spray-drying process for the production of echogenic microparticles, whose concave surface segments are the first and foremost characteristic, is disclosed in European Patent EP 0 535 387 B1. The synthesis of various shell polymers, i.a., with use of organic solvent is described. The echogenic microparticles are obtained by a spray-drying process of an organic solution of the shaping polymer. Disadvantageous in this process is also the use of organic solvents and the spray-drying process that is expensive under sterile conditions.

By process optimization, which is described in European Patent EP 0 644 777 B1, the ultrasonic effectiveness of the microparticles that are described in EP 0 398 935 B1 could be significantly improved. An increase of the ultrasonic effectiveness (with specific frequency and smaller amplitude) is achieved by the diameter of the air core having been enlarged in the case of constant particle diameter. Despite the smaller wall thickness that results therefrom, the particles nevertheless survive passing through the cardiopulmonary system.

The gas-filled microparticles according to EP 0 644 777 (microcapsules in terms of this application) emit, moreover, an independent signal regardless of the scattering upon excitation with ultrasound of suitable frequency and amplitude (sonic pressure). Emitting independent signals is accompanied by the destruction of gas-filled microcapsules and is referred to as stimulated acoustic emission (SAE). The frequency of the emitted independent signals deviates from the excitation frequency in this case, and the signal amplitude here is higher than that of a scattered signal from undestroyed ultrasonic contrast media. The SAE signal can also be detected by means of the color Doppler mode in essentially motionless gas-filled microcapsules. This detection method is disclosed in U.S. Pat. No. 5,425,366.

The ultrasonic contrast media that can be produced according to EP 0 644 777 contain gas-filled microcapsules, whose properties have a range of variation, i.e., over a certain range, for example, the particle size, the wall thickness, the destructibility by ultrasound and primarily the ability to emit SAE signals vary within the population. Since, moreover, the sonic pressure in the scanning field is inhomogeneous, the destructibility of the gas-filled microcapsules and their ability to emit an SAE signal over a certain depth range depend on where the gas-filled microcapsules are in the tissue being examined (site-dependent destructibility).

The optimized process according to EP 0 644 777 is characterized in that the monomer is dispersed and polymerized directly in an acidic, gas-saturated, aqueous solution, and in this case the build-up of the microcapsules is carried out. In this way, gas-filled microcapsules can be produced without being dependent on organic solvents during the production process.

Difficulties arise in this process, however, during scale-up from the laboratory scale to the production scale, since the input of energy into the reaction medium depends to a considerable extent on the rpm and the diameter of the stirring or dispersing element. Consequently, it can be expected that the sensible ratios for the input of energy and air cannot easily be scaled up locally at the dispersing tool or the shear gradient within the reactor. By the large amount of air introduced at the dispersing tool, a considerable formation of foam can be observed, so that it is not possible to make adequate statements regarding the extent to which polymerization of the shell-shaping substance(s) and the build-up of microcapsules are carried out in a way according to requirements.

A new production process for echogenic microcapsules should not have any of the above-mentioned drawbacks, i.e.,

The production of microcapsules must also be simple and reproducible under sterile conditions,

the synthesis of the polymer and the microcapsule production must be feasible without organic solvents,

scaling-up must be possible while retaining process control, and process monitoring must be easy,

the microcapsules that can be produced with the process are to have an optimally adapted property profile as ultrasonic contrast media (defined size or size distribution, qualitatively and quantitatively reproducible ultrasonic contrasts),

the microcapsules should have a high shelf life even under critical climatic conditions.

It has been found that not only nascent primary latex particles can form microcapsules during the polymerization process, but can also cause microcapsule formation with completely polymerized or pre-polymerized primary dispersions by suitable process control.

This production option makes it possible to break the comparatively complicated overall production process down into smaller steps.

In a first process step, polymerization of the shell-shaping substance(s) takes place, and in a process step that is separated from it in space and/or time, the formation of the microcapsules by a build-up process takes place. The partial processes of polymerization and microcapsule formation are thus separated, and the overall production process is subject to a better control.

Each process step can be performed under the optimal process conditions in each case, such as, for example, temperature, pH, amount of the gas input.

The possibility thus exists of first producing a primary dispersion that is optimally suitable for the formation of microcapsules to then produce the latter in another process step after setting the optimal conditions for the formation of microcapsules. This can advantageously be carried out immediately following polymerization.

A batch does not have to be completely processed.

That is to say, the option exists of merging several different primary dispersions that can also contain, in each case, various polymers to build up gas-filled microcapsules therefrom.

A primary dispersion can also be divided into portions that each are then further built up into gas-filled microcapsules. In addition, necessary or optimally suitable adjuvants can be added to the process steps below.

After the formation of the microcapsules is completed, all possibilities are open for further processing: e.g., the separation of gas-filled microcapsules based on the density difference in the liquid medium. With sufficiently pressure-stable microcapsules, centrifuging, etc., can be carried out.

For the build-up of gas-filled microcapsules, it is necessary to introduce gas into the medium so that a gas-phase portion (Φ_{G}) of >1%, preferably >10%, results.

This can be ensured by, for example, dispersion conditions.

By dispersion, a self-gassing of the medium is carried out, and a gas-phase portion (Φ_{G}) of >1% results.

Dispersion conditions can be produced with, for example, rotor-stator systems. These produce strong shear gradients and introduce bubbles into the medium (self-gassing). This is associated with a high energy input, so that optionally heat must be drawn off.

The gas bubbles that are produced by dispersion, however, do not have any defined narrow size distribution. The input of gas by dispersion therefore makes more difficult the control of the size distribution of gas-filled microcapsules and especially the assurance of batch conformity.

The populations of gas-filled microcapsules of the prior art have drawbacks as ultrasonic contrast media.

Primarily the variation range of the microcapsule properties within a microcapsule population results in that within a sonic field at a low sonic pressure, only a portion of the gas-filled microcapsules that are actually present there are excited into SAE signals, while the others react only at higher sonic pressure. Since in addition the sonic pressure in the scanning field (sonic field) is not homogeneous (tissue attenuation, focus), the SAE signal yield does not correspond to the actual microcapsule number in the microcapsule populations of the prior art. Depending on the sonic field, only one more or less of a large fraction of the population is represented. Against this background, therefore, gas-filled microcapsules that are excited to SAE signals in as narrow a range as possible (relative to the sonic field), preferably at a low sonic pressure, would be desirable.

The object of this invention is therefore to control the production of gas-filled microcapsules in such a way that the size distribution of the gas-filled microcapsules is better controlled, and a maximum amount of batch conformity can be achieved. Populations of gas-filled microcapsules that have a low variation width with respect primarily to the acoustic properties of the microcapsules are made ready. The gas-filled microcapsules of a population according to the invention are to react as uniformly as possible to the sonic pressure; in particular there should be little difference between them as regards their destructibility by ultrasound and their ability to emit SAE signals.

The object of this invention is achieved by a multi-stage production process, in which the polymerization of the shell-shaping substance and the build-up of microcapsules is carried out separately in space and/or time, whereby during the build-up of the microcapsules, a gas feed unit introduces gas bubbles of defined size into the medium (defined external gassing). The build-up of microcapsules is carried out like the polymerization of the shell-shaping substance(s), in this case while being stirred, so that essentially no self-gassing of the medium takes place. The gas feed unit consists of, for example, a sintered filter with a defined pore size.

The populations of gas-filled microcapsules that can be produced with the process according to the invention are distinguished by a small variation width with respect to their size, wall thickness, destructibility by ultrasound and their ability to emit SAE signals.

As a result, the destructibility of the gas-filled microcapsules in the scanning field is less site-dependent. In addition, the proportion of gas-filled microcapsules that emit an SAE signal at a fixed sonic pressure is increased. This means that the population according to the invention is significantly more effective than the populations of gas-filled microcapsules of the prior art. In addition, by the small variation of the sonic pressure reaction, the populations of gas-filled microcapsules according to the invention are suitable in quantification studies.

In addition to the decoupling of polymerization and build-up of microcapsules, the production process according to the invention allows, moreover, an especially simple scaling-up, since the strong nonlinear effects of the input of energy, such as occur during dispersion with input of gas, are avoided.

The first process step, the polymerization of shell-shaping substance(s), is carried out in this case in aqueous, often acidic solution while being stirred essentially without self-gassing or external gassing in such a way that the gas-phase portion (Φ_{G}) in the stirring medium is <1%.

As a whole, the production of the primary dispersion should be carried out so that no optically detectable increase of the volume of the reaction medium is carried out by the input of gas.

These are generally moderate conditions that are characterized in an open reactor by an input of energy of less than 5 W/dm³ and a Reynolds number (Re=n·d²/v) of less than 50,000. If the polymerization is carried out in a closed system that is, for example, hydraulically filled, a polymerization according to requirements can also be performed at considerably different operating points. In any case, vortex formation can be detected, if only to a slight extent.

As an intermediate product of this process step, a primary dispersion that consists of colloidal polymer particles is obtained.

The thus produced polymer particles in the primary dispersion can consist of a homopolymer or else a copolymer.

In addition, various monomers can also be polymerized in succession, so that the primary dispersion essentially contains polymer particles that consist of polymers of various monomers.

In another variant, a pre-fabricated polymer such as PLGA can also be added to the monomer.

The degradability in the organism can be controlled specifically by these variants.

As monomers, lactides, alkyl esters of acrylic acid, alkyl esters of methacrylic acid and preferably alkyl esters of cyanoacrylic acid can be used.

Especially preferred are butyl, ethyl and isopropylcyanoacrylic acid (abbreviations: BCA, ECA, IPCA).

The stirring medium can contain one or more of the following surfactants:

Alkylarylpoly(oxyethylene)sulfate alkali salts, dextrans, poly(oxyethylenes), poly(oxypropylene)-poly(oxyethylene)-block polymers, ethoxylated fatty alcohols (cetomacrogols), ethoxylated fatty acids, alkylphenolpoly(oxyethylenes), copolymers of alkylphenolpoly(oxyethylene)s and aldehydes, partial fatty acid esters of sorbitan, partial fatty acid esters of poly(oxyethylene)sorbitan, fatty acid esters of poly(oxyethylene), fatty alcohol ethers of poly(oxyethylene), fatty acid esters of saccharose or macrogol glycerol esters, polyvinyl alcohols, poly(oxyethylene)-hydroxy fatty acid esters, macrogols of multivalent alcohols, partial fatty acid esters.

The following are preferably used:

Ethoxylated nonylphenols, ethoxylated octylphenols, copolymers of aldehydes and octylphenolpoly(oxyethylene), ethoxylated glycerol-partial fatty acid esters, ethoxylated hydrogenated castor oil, poly(oxyethylene)-hydroxystearate, poly(oxypropylene)-poly(oxyethylene)-block polymers with a molar mass of <20,000.

Especially preferred surfactants are:

Para-octylphenol-poly-(oxyethylene) with 9-10 ethoxy groups on average (=octoxynol 9,10), para-nonylphenol-poly(oxyethylene) with 30/40 ethoxy groups on average (=e.g., Emulan^{(R)}30/Emulan^{(R)}40), para-nonylphenol-poly(oxyethylene)-sulfate-Na salt with 28 ethoxy groups on average (=e.g., Disponil^{(R)} AES), poly(oxyethylene)glycerol monostearate (e.g., Tagat^{(R)} S), polyvinyl alcohol with a degree of polymerization of 600-700 and a degree of hydrolysis of 85%-90% (=e.g., Mowiol^{(R)} 4-88), poly(oxyethylene)-660-hydroxystearic acid ester (=e.g., Solutol^{(R)} HS 15), copolymer of formaldehyde and para-octylphenolpoly(oxyethylene) (=e.g., Triton^{(R)} WR 1339), polyoxypropylene-polyoxyethylene-block polymers with a molar mass of about 12,000 and a polyoxyethylene proportion of about 70% (=e.g., Lutrol^{(R)} F127), ethoxylated cetylstearyl alcohol (=e.g., Cremophor^{(R)} A25), ethoxylated castor oil (=e.g., Cremophor^{(R)} EL).

In the preferred process variant, one or more monomer(s) from the group of the cyanoacrylic acid alkyl ester in an acidic, aqueous solution is added in drops in the process step of the polymerization. The addition is carried out under moderate stirring conditions, such that no self-gassing is carried out.

A degassing of the reaction media can, but must not be carried out. The reaction media usually have the temperature-dependent gas content of the gas (of the gases) of the surrounding atmosphere. The production generally should be carried out in such a way that no optically detectable increase in the volume of the reaction medium is carried out by the input of gas (Φ_{G}<1%)

The type of dosage in connection with the other internals that contribute to thorough mixing, the stirrer and the rpm also should be selected such that the mixing time in comparison to the reaction period of the polymerization process is very small to ensure the quickest possible micromixing of the monomer in the acidic, aqueous solution.

When done properly, no foam is observed to form. During polymerization, only very little or no input of gas is carried out, and cavitation effects are excluded because of moderate stirring conditions. It is very readily possible, by using suitable on-line process probes (e.g., IR, NIR or Raman probes for conversion), which are often of no use in strongly foaming reaction media; to structure reaction and process control in a safe manner.

It is also possible, after the reaction ends, to test the primary dispersion and conventionally to perform off-line analysis. Thus, e.g., the mean particle size and distribution can then be determined.

The feed of monomers during semi-continuous polymerization represents another, also successfully performed technique for setting desired particle size distributions, so that the growth of a particle population that is generated in the initial phase of the polymerization is influenced specifically.

The polymerization is performed at temperatures of −10° C. to 60° C., preferably in a range of 0° C. to 50° C. and especially preferably between 3° C. and 25° C.

Setting the reaction speed of the polymerization of the cyanoacrylic acid ester and the mean particle size that results therefrom is carried out, i.a., in addition to the temperature, via the pH that can be set based on acid and concentration in a range of 1.0 to 4.5, for example by acids, such as hydrochloric acid, phosphoric acid and/or sulfuric acid. Other values of influence on the reaction speed are the type and concentration of the surfactant and the type and concentration of additives.

The monomer or the monomers is(are) added at a concentration of 0.1 to 60%, preferably 0.1 to 10%, to the aqueous, mostly acidic, solution. In an implementation according to the above-mentioned conditions, the polymerization time is between 2 minutes and 2 hours and can be tracked, i.a., by reaction-calorimetry. his wide range of the reaction time is a result of the flexible variation possibilities in the selection of the process parameters, with which the particle size as well as the particle size distribution of the polymer latex particles that are produced can be controlled.

The latter are the central values of influence in the subsequent formation of the gas-filled microcapsules, which thus can be influenced in a positive manner by the selection of suitable polymerization parameters.

The diameter of the polymer latex particles that are produced according to this formulation for the encapsulation of gas lies in a range of 30 nm to 500 nm, preferably in a range of 50 nm to 300 nm, especially advantageously in a range of 80 nm to 180 nm. The thus produced polymer particles have a controllable size distribution with a polydispersity down to a range of 1.4 to 1.0 (d_{w}/dₙ). The measurements of the nanoparticle size were carried out with the measuring device NICOMP Submicron Particle Sizer Model 370, Manufacturer Particle Sizing Systems.

There are no sterility problems in this simple reaction structuring. For the aseptic fabrication of microcapsules, it is possible to subject this polymerization dispersion to a sterile filtration, such that the aseptic fabrication process can be carried out simply.

Following the polymerization, as a further advantage of this multi-stage process, a large proportion that is optionally produced during polymerization can be separated (e.g., by filtration), such that the latter no longer has a disturbing effect on the formation process of the microcapsules.

In addition to other process steps, such as the already mentioned filtration, dialysis is also possible. Thus, the surfactant content of the primary dispersion can be reduced again. The surfactant can then be replaced completely or partially by another for the next step, the build-up process of completely polymerized latex particles into microcapsules. In addition, other adjuvants can be added.

The formation of the gas-filled microcapsules is carried out in another step by structure-building aggregation of the colloidal polymer particles. This process step is carried out separately in space and/or time from the production of the primary dispersion.

The build-up of microcapsules from the primary dispersion is also carried out while being stirred essentially without self-gassing, but with defined external gassing in such a way that a gas-phase portion (Φ_{G}) of 1%, preferably greater than 10%, results.

To this end, a gas that is defined is introduced while being stirred into the primary dispersion with the aid of a suitable device.

The defined narrow size distribution of the gas-filled microcapsules is made possible by a defined external gassing. The input of gas is carried out in this case via a gas feed unit that generates gas bubbles with a defined size. This can be carried out, for example, by means of a sintered filter of a defined pore size of, e.g., 1 μm. In this case, i.a., the gas bubble size depends on the material of the sintered filter (e.g., metal or plastic) and on gas throughput. These parameters are easy to monitor.

A defined external gassing is also possible with plates, which were perforated in a defined manner by means of a laser or by means of capillaries with defined openings.

The size of microcapsules can be easily controlled by variation of the gas throughput in otherwise uniform boundary conditions. Gas-filled microcapsules with a defined narrow size distribution can be produced.

Moreover, in this way gases or gas mixtures that are otherwise very difficult to encapsulate, such as, e.g., argon or helium, can be encapsulated, and the proportion of deposited microparticles is especially small.

As gassing units, sintered filters that consist of metal, plastic, glass or ceramic, especially steel or Teflon with small defined pore openings, are suitable. In this case, the phase portion of gas Φ_{G} in the reaction mixture increases to values of significantly over 1%, generally more than 10%. The gas-phase portion (Φ_{G}) in the medium is often even more than 50%. This is associated with a correspondingly large increase in the volume of the reaction mixture. An intensive formation of foam is carried out that can be quantified via a transmission measurement by a cloudiness sensor.

The sintered filters that are used according to the invention have a pore size of 0.05 μm to 1000 μm, preferably 0.1 μm to 100 μm and especially preferably from 0.25 μm to 25 μm.

The build-up of the microcapsules is performed at temperatures of −10° C. to 60° C., preferably in a range of 0° C. to 50° C. and especially preferably between 10° C. and 35° C.

In addition to the basic values, such as temperature, formulation, etc., important values for the build-up reaction of the microcapsules and thus for the size and the size distribution of the gas-filled microcapsules are the gas-phase portion, the gas flow rates, the pressure, the pore size of the gassing unit, and the conditions of the gassing unit as such. Depending on the hydrophobicity of the material, different, but nevertheless well-defined, narrowly distributed bubbles are formed with the same pore openings, same gas flow rates, etc.

An enhancement of the build-up of gas-filled microcapsules can be carried out in addition by the addition of suitable adjuvants, such as, for example, water-soluble salts or lower monovalent alcohols.

The diameter of the gas-filled microcapsules is in a range of 0.2-50 μm, in the case of parenteral agents preferably between 0.5 and 25 μm and especially preferably between 0.5 and 10 μm. The measurements of the microcapsule size were made with the measuring device Accusizer Model CW 770 of the Manufacturer Particle Sizing Systems.

In general, the production of gas-filled microcapsules can be carried out in continuous, semi-continuous or batch operation.

For the polymerization of the monomer and for the build-up of microcapsules, a reactor or a combination of several reactors of the type of a stirring vessel, a flow pipe or a loop reactor can be used for thorough mixing taking suitable precautions. For the build-up of microcapsules, the reactor that is used must have a suitable gas feed unit that allows a defined external gassing.

As a discontinuous reactor, especially a stirring vessel with a ratio of diameter to height in a range from 0.3 to 2.5, which is equipped with a temper jacket, is suitable.

The polymerization of the monomer and the build-up of microcapsules is carried out preferably with a stirring element that has a ratio of stirrer diameter to reactor diameter in a range of 0.2 to 0.7.

As stirring elements, in principle all commonly used stirrers are considered, but especially those that are used for the thorough mixing of low-viscous, water-like media (<10 mPas). These include, for example, propeller stirrers, vane stirrers, pitched-blade stirrers, MIG^{(R)} stirrers and disk stirrers, etc. The insertion position can be, e.g., vertically in the direction of the normal of the liquid surface of the reaction medium, in oblique form against the normal or laterally through the container walls. The latter possibility arises in the case of a container that is filled completely gas-free and externally encapsulated against the atmosphere.

The use of flow-breakers is also possible. In this connection, it is ensured that the tendency toward self-gassing in an open system is especially low in the production of the primary dispersion.

By the comparatively readily understood hydrodynamics of a discontinuous stirring vessel, there are no significant difficulties in the case of scaling-up from the laboratory scale to the industrial scale or the production scale, which has to be evaluated as advantageous for the commercial application of this process.

A concrete process variant consists in performing the production of the primary dispersion in a continuous reactor, whereby to this end tube reactors with their tightly defined dwell-time behavior are more suitable than stirring vessel reactors. By the suitable selection of polymerization parameters, the reactor geometry and the mean dwell time can be ensured in a simple way in a tube reactor, such that the polymerization at the end of the tube reactor is fully completed. The possibility of on-line analysis exists just like in the batch reactor.

At the end of the tube reactor, a gassing unit also can be used for the build-up reaction of microcapsules, so that the entire process is performed in a single apparatus, and the two process steps, the production of a polymer dispersion and the build-up reaction of microcapsules nevertheless are decoupled from one another.

Another process variant calls for the use of a loop reactor with a gassing unit that consists of a continuous stirring vessel or optionally a discontinuous stirring vessel with an outside loop. In this case, the production of the primary dispersion is carried out either in the stirring vessel area under moderate stirring conditions as well as in the closed loop or in the entire loop reactor when the loop is open, specifically under circulation conditions that do not allow any self-gassing by correspondingly adjusted speed ranges.

During the production of the primary dispersion, the gassing unit remains out of service.

After the end of the reaction, the loop is optionally opened, and in any case the gassing unit is turned on to make the build-up reaction possible. Scaling-up can be done particularly easily here, since the process depends on only a few parameters.

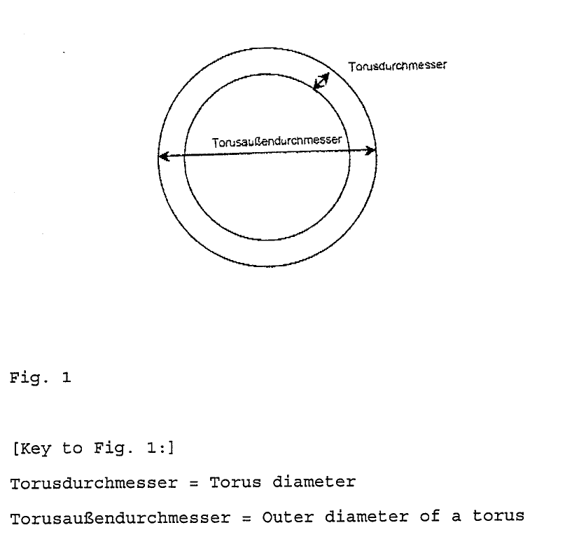

The polymerization of the shell-shaping substance(s) and/or the build-up of microcapsules can also be performed, moreover, in a discontinuous, semi-continuous or continuous torus-like loop reactor with a diameter ratio of outside diameter of the outside loop to the torus diameter of 2.1 to 20 (FIG. 1).

After the two process steps are completed, the reaction batch can be further worked up.

The separation of gas-filled microcapsules from the reaction medium is advisable.

This can be done in a simple way with use of the density difference by flotation or centrifuging. In both cases, the gas-filled microcapsules form a floated material, which can be separated easily from the reaction medium.

The floated material that is obtained can then be taken up with a physiologically compatible vehicle, in the simplest case water or physiological common salt solution.

The microcapsule dispersion can be administered immediately. Dilution optionally is advisable.

The separation process can also be repeated one or more times. By directed setting of the flotation conditions, fractions with defined properties can be obtained.

The microcapsule dispersions are stable over a very long period, and the gas-filled microcapsules do not aggregate.

The durability can nevertheless be improved by subsequent freeze-drying optionally after the addition of polyvinylpyrrolidone, polyvinyl alcohol, gelatin, human serum albumin or another cryoprotector that is familiar to one skilled in the art.

The subjects of this invention are, moreover, the gas-filled microcapsules that can be produced with the process according to the invention. The microcapsule population is distinguished in that the acoustic properties of the gas-filled microcapsules have a low variation width, i.e., the reaction to sonic pressure, especially the destructibility and the ability to emit SAE signals, is narrowly distributed.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosure of all applications, patents and publications, cited above [or below], and of corresponding German application No. 100 65 068.6, filed Dec. 21, 2000 is hereby incorporated by reference.

The invention is explained by the following examples:

### EXAMPLE 1

a) Production of Nanoparticles (Primary Dispersion)

In a 1 l glass reactor with a diameter to height ratio of 0.5, 800 ml of water is adjusted to a pH of 2.5 and a reactor temperature of 280 K by adding 1N hydrochloric acid. While being stirred moderately with a propeller stirrer, 8.0 g of octoxynol is added and stirred until the octoxynol is completely dissolved. Then, under the same stirring conditions over a period of 30 minutes, 11.20 g of cyanoacrylic acid butyl ester (BCA) is added in drops, and the solution is stirred for another 30 minutes, so that no air is introduced. After the polymerization is completed, the primary dispersion is filtered to separate larger polymer particles.

b) Production of Gas-Filled Microcapsules

The filtered primary dispersion is gassed with air for 10 hours at a volumetric rate of flow of 20 L/h with a sintered filter (A=200 cm²) that is made of metal with a pore width of 3 μm while being stirred. The floated material is separated from the reaction medium and taken up with 600 ml of water for injection purposes. Then, 60 g of polyvinylpyrrolidone is dissolved in the batch, the microcapsule dispersion is formulated to 5 g and freeze-dried.

### EXAMPLE 2

a) Production of Nanoparticles (Primary Dispersion)

In a 1 l glass reactor with a diameter to height ratio of 0.5, 800 ml of water is adjusted to a pH of 2.5 and a reactor temperature of 280 K by adding 1N hydrochloric acid. While being stirred moderately with a magnetic stirrer, 8.0 g of octoxynol is added and stirred until the octoxynol is completely dissolved. Then, under the same stirring conditions over a period of 5 minutes, 11.20 g of cyanoacrylic acid butyl ester is added in drops, and the solution is stirred for another 30 minutes, so that no air is introduced. After the polymerization is completed, the primary dispersion is filtered to separate larger polymer particles.

b) Production of Gas-Filled Microcapsules

The filtered primary dispersion is gassed with carbon dioxide for 10 hours at a volumetric rate of flow of 20 L/h with a sintered filter (A=200 cm²) that is made of metal with a pore width of 3 μm while being stirred. The floated material is separated from the reaction medium and taken up with 600 ml of water for injection purposes. Then, 60 g of polyvinylpyrrolidone is dissolved in the batch, the microcapsule dispersion is formulated to 5 g and freeze-dried.

### EXAMPLE 3

a) Production of Nanoparticles (Primary Dispersion)

In a 1 l glass reactor with a diameter to height ratio of 0.5, 800 ml of water is adjusted to a pH of 2.2 and a reactor temperature of 290.5 K by adding 1N hydrochloric acid. While being stirred moderately with a propeller stirrer, 8.0 g of octoxynol is added and stirred until the octoxynol is completely dissolved. Then, under the same stirring conditions over a period of 5 minutes, 11.20 g of cyanoacrylic acid butyl ester is added in drops, and the solution is stirred for another 30 minutes, so that no air is introduced. After the polymerization is completed, the primary dispersion is filtered to separate larger polymer particles.

b) Production of Gas-Filled Microcapsules

The filtered primary dispersion is gassed with helium for 10 hours at a volumetric rate of flow of 5 l/h with a sintered filter (A=200 cm²) that is made of metal with a pore width of 3 μm while being stirred. The floated material is separated from the reaction medium and taken up with 600 ml of water for injection purposes.

### EXAMPLE 4

a) Production of Nanoparticles (Primary Dispersion)

In a 20 l steel reactor with a diameter to height ratio of 0.5, 10 l of water is adjusted to a pH of 2.2 and a reactor temperature of 280 K by adding 1N hydrochloric acid. While being stirred moderately with a propeller stirrer, 100 g of octoxynol is added and stirred until the octoxynol is completely dissolved. Then, under the same stirring conditions over a period of 30 minutes, 100 g of cyanoacrylic acid butyl ester is added in drops, and the solution is stirred for another 6 hours, so that no air is introduced. After the polymerization is completed, the primary dispersion is filtered to separate larger polymer particles.

b) Production of Gas-Filled Microcapsules

The filtered primary dispersion is gassed with argon for 10 hours at a volumetric rate of flow of 10 l/h with a sintered filter that is made of Teflon (surface area=5 cm²) with a pore width of 1 μm while being stirred. The floated material is separated from the reaction medium and taken up with 2000 ml of water for injection purposes.

### EXAMPLE 5

Self-Gassing/Defined External Gassing Comparison Test

A. Defined External Gassing

a) Production of Nanoparticles (Primary Dispersion)

1. In a 10 l glass reactor with a diameter to height ratio of 0.5, 5 l of water is adjusted to a pH of 1.5 and a reactor temperature of 290 K by adding 1N hydrochloric acid (ice cooling). While being stirred with a magnetic stirrer, 5 g of octoxynol is added and stirred until the octoxynol is completely dissolved. Then, under the same stirring conditions over a period of 240 minutes, 70 g of cyanoacrylic acid butyl ester is added in drops. After one more hour of stirring at the same temperature so that no air is introduced, the content of the primary dispersion is adjusted to 1% octoxynol and then filtered to separate larger polymer particles. A primary dispersion with a particle diameter of 236 nm is obtained (measuring device NICOMP Submicron Particle Sizer Model 370, Manufacturer Particle Sizing Systems).

2. In a 10 l glass reactor with a diameter to height ratio of 0.5, 5 l of water is adjusted to a pH of 1.5 and a reactor temperature of 290 K by adding 1N hydrochloric acid (ice cooling). While being stirred with a magnetic stirrer, 20 g of octoxynol is added and stirred until the octoxynol is completely dissolved. Then, under the same stirring conditions over a period of 240 minutes, 70 g of cyanoacrylic acid butyl ester is added in drops. After one more hour of stirring at the same temperature so that no air is introduced, the content of the primary dispersion is adjusted to 1% octoxynol and then filtered to separate larger polymer particles. A primary dispersion with a particle diameter of 105 nm is obtained (measuring device NICOMP Submicron Particle Sizer Model 370, Manufacturer Particle Sizing Systems).

3. In a 10 l glass reactor with a diameter to height ratio of 0.5, 5 l of water is adjusted to a pH of 1.5 and a reactor temperature of 290 K by adding 1N hydrochloric acid. While being stirred with a magnetic stirrer, 50 g of octoxynol is added and stirred until the octoxynol is completely dissolved. Then, under the same stirring conditions over a period of 240 minutes, 70 g of cyanoacrylic acid butyl ester is added in drops. After one more hour of stirring at the same temperature, it is then filtered to separate larger polymer particles. A primary dispersion with a particle diameter of 45 nm is obtained (measuring device NICOMP Submicron Particle Sizer Model 370, Manufacturer Particle Sizing Systems).

b) Production of Gas-Filled Microcapsules

The filtered primary dispersion according to 1) to 3) is transferred in each case into a 10 l glass flask and gassed with synthetic air for 24 hours at a volumetric rate of flow of 10 l/h with a sintered filter that is made of steel (surface area=200 cm²) with a pore width of 3 μm while being stirred. The floated material is separated from the reaction medium and taken up with 1000 ml of water for injection purposes.

B. Self-Gassing

a) Production of Nanoparticles (Primary Dispersion)

4. In a 10 l glass reactor with a diameter to height ratio of 0.5, 5 l of water is adjusted to a pH of 2.2 and a reactor temperature of 290 K by adding 1N hydrochloric acid (ice cooling). While being stirred with a magnetic stirrer, 50 g of octoxynol is added and stirred until the octoxynol is completely dissolved. Then, under the same stirring conditions over a period of 240 minutes, 70 g of cyanoacrylic acid butyl ester is added in drops. After one more hour of stirring at the same temperature, it is filtered to separate larger polymer particles. A primary dispersion with a particle diameter of 70 nm is obtained (measuring device NICOMP Submicron Particle Sizer Model 370, Manufacturer Particle Sizing Systems).

b) Production of Gas-Filled Microcapsules

This primary dispersion is transferred into a 20 l steel loop reactor with a rotor-stator inline dispersing unit. At a speed of the dispersing unit of 6000 rpm (corresponds here to about 20 m/s), the primary dispersion is processed for 3 hours in a cycle. The floated material is removed from the reaction medium and taken up with 3000 ml of water for injection purposes.

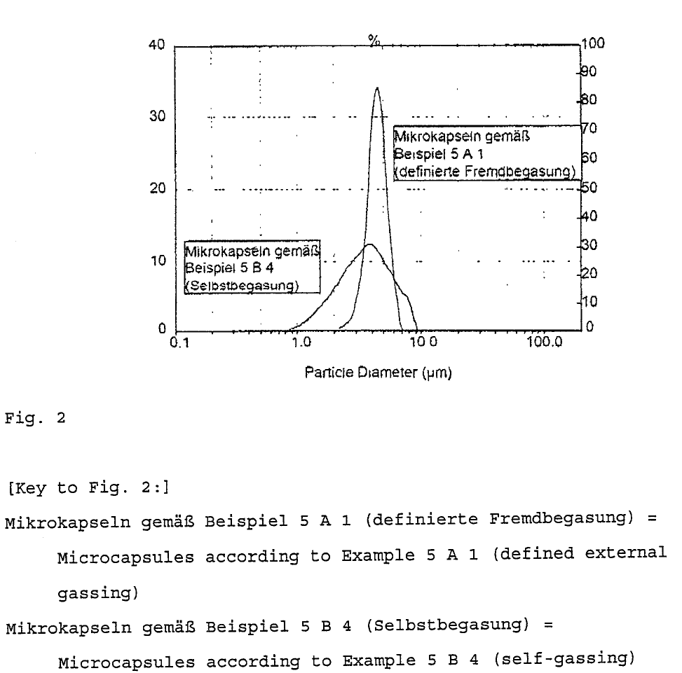

The particle size distribution of the microcapsules that are produced according to 1) and 4) is shown in FIG. 2. The mean volume-weighted particle size for the process according to 1) is 4.18 μm and for the process according to 4) is 2.85 μm. It is clearly discernible that the microcapsules that are produced according to the invention with defined external gassing have a significantly more narrow size distribution than that produced by self-gassing.

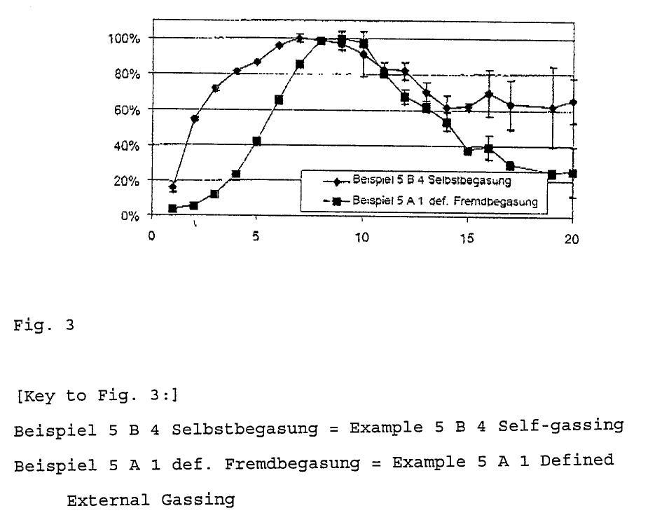

This is also reflected in the fact that in the ultrasonic attenuation spectrum of the product that is produced according to the invention, a clearly discernible attenuation maximum is produced, in contrast to the product that has been produced via the self-gassing with a dispersing unit (FIG. 3). With the process according to the invention, especially well defined microcapsules are therefore produced.

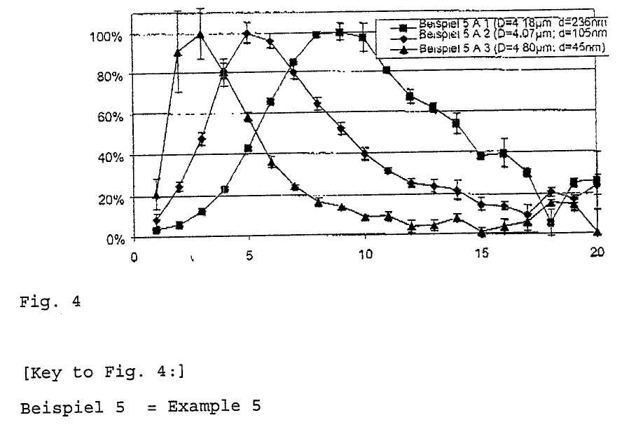

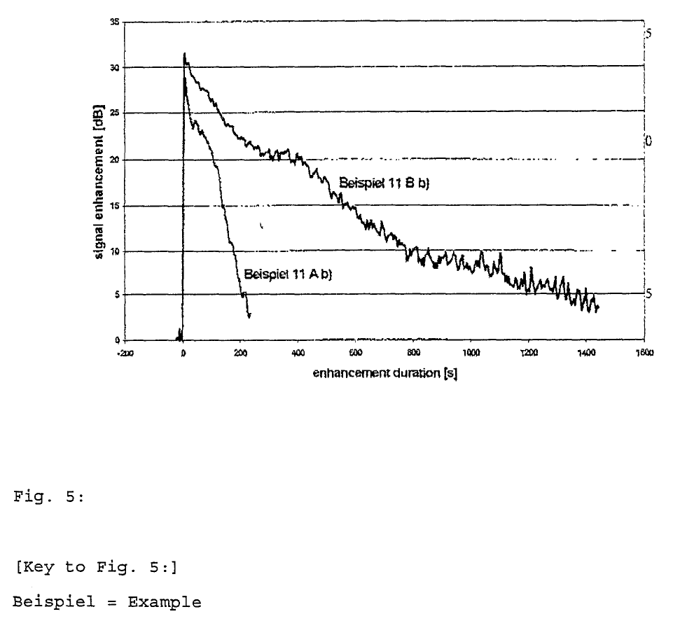

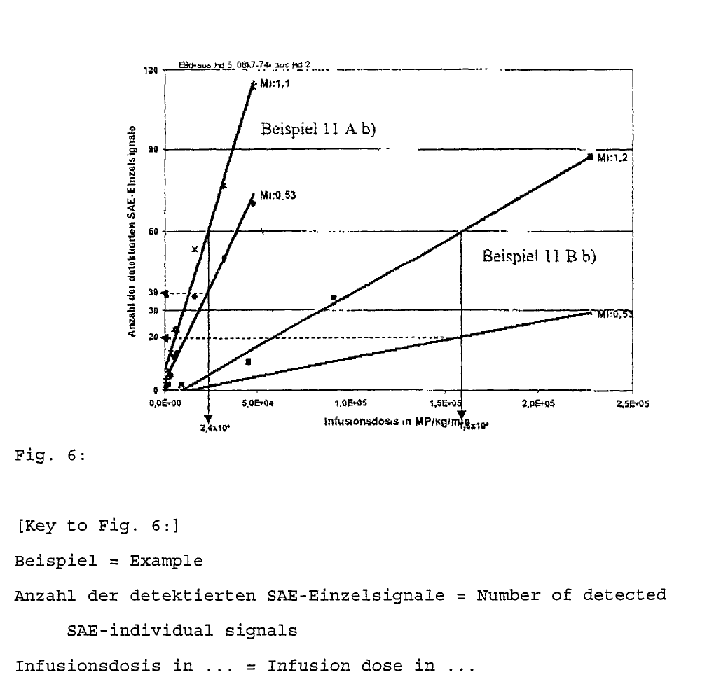

In FIG. 4, it can be seen that with the process according to the invention, the location of the attenuation maximum in the ultrasonic spectrum can be controlled specifically. This is made possible by the size of the polymer particles that build up the microcapsule shell.

### EXAMPLE 6

a) Production of Nanoparticles (Primary Dispersion)

In a 10 l glass reactor with a diameter to height ratio of 0.5, 5 l of water is adjusted to a pH of 1.5 and a reactor temperature of 290 K by adding 1N hydrochloric acid. While being stirred with a magnetic stirrer, 50 g of octoxynol is added and stirred until the octoxynol is completely dissolved. Then, under the same stirring conditions over a period of 30 minutes, 70 g of cyanoacrylic acid butyl ester is added in drops, and the solution is stirred for another 6 hours so that no air is introduced. After the polymerization is completed, the primary dispersion is filtered to separate larger polymer particles.

b) Production of Gas-Filled Microcapsules

The filtered primary dispersion is transferred into a 5 l loop reactor that is made of high-grade steel and gassed with argon for 24 hours at a volumetric rate of flow of 5 l/h with a sintered filter that is made of steel (surface area=100 cm²) with a pore width of 1 μm while being stirred. The floated material is separated from the reaction medium and taken up with 1000 ml of water for injection purposes.

### EXAMPLE 7

a) Production of Nanoparticles (Primary Dispersion)

In a 10 l glass reactor with a diameter to height ratio of 0.5, 5 l of water is adjusted to a pH of 1.5 and a reactor temperature of 290 K by adding 1N hydrochloric acid. While being stirred moderately with a magnetic stirrer, 50 g of octoxynol is added and stirred until the octoxynol is completely dissolved. Then, under the same stirring conditions over a period of 30 minutes, 70 g of cyanoacrylic acid butyl ester is added in drops, and the solution is stirred for another 6 hours so that no air is introduced. After the polymerization is completed, the primary dispersion is filtered to separate larger polymer particles.

b) Production of Gas-Filled Microcapsules

The filtered primary dispersion is gassed with argon for 24 hours at a volumetric rate of flow of 5 l/h with a sintered filter that is made of steel (surface area=100 cm²) with a pore width of 1 μm while being stirred. In addition, at the beginning, 50 ml of ethanol is added. The floated material is separated from the reaction medium and taken up with 1000 ml of water for injection purposes.

### EXAMPLE 8

a) Production of Nanoparticles (Primary Dispersion)

In a 2 l glass reactor with a diameter to height ratio of 0.7, 960 ml of water is adjusted to a pH of 1.5 and a temperature of 290 K by adding 1N hydrochloric acid. While being stirred moderately with a magnetic stirrer, 10 g of octoxynol is added and stirred until the octoxynol is completely dissolved. Then, under the same stirring conditions over a period of 30 minutes, a solution of 1 g of a PLGA (Resomer 752) in 13.5 g of cyanoacrylic acid butyl ester is added in drops, and the mixture is stirred for another 6 hours so that no air is introduced. After the polymerization is completed, the primary dispersion is filtered to separate larger polymer particles.

b) Production of Gas-Filled Microcapsules

Half of the filtered primary dispersion is transferred into a 1 l glass reactor with a ratio of height H to diameter D of 10 and gassed with argon for 6 hours at a volumetric rate of flow of 5 l/h with a sintered filter that is made of Teflon (surface area =10 cm²) with a pore width of 1 μm while being stirred. The floated material is separated from the reaction medium and taken up with 500 ml of water for injection purposes.

### EXAMPLE 9

a) Production of Nanoparticles (Primary Dispersion)

In a 2 l glass reactor with a diameter to height ratio of 0.7, 960 ml of water is adjusted to a pH of 1.5 and a temperature of 290 K by adding 1N hydrochloric acid. While being stirred moderately with a magnetic stirrer, 10 g of octoxynol is added and stirred until the octoxynol is completely dissolved. Then, under the same stirring conditions over a period of 30 minutes, 5 g of cyanoacrylic acid ethyl ester (ECA) is added in drops, and the mixture is stirred for another 6 hours so that no air is introduced. After the polymerization is completed, the primary dispersion is filtered to separate larger polymer particles. In another step, 15 g of BCA is added in drops under the same conditions as in the case of the addition of ECA.

b) Production of Gas-Filled Microcapsules

A portion of the filtered primary dispersion is transferred into a 1 l glass reactor with a ratio of height H to diameter D of 10. Then, it is gassed with compressed air for 6 hours at a volumetric rate of flow of 5 l/h with a sintered filter that is made of polyethylene (surface area=10 cm²) with a pore width of 10 μm while being stirred. The floated material is separated from the reaction medium and taken up with 500 ml of water for injection purposes.

### EXAMPLE 10

a) Production of Nanoparticles (Primary Dispersion)

In a 10 l glass reactor with a diameter to height ratio of 0.5, 5 l of water is adjusted to a pH of 1.5 and a reactor temperature of 290 K by adding 1N hydrochloric acid. While being stirred moderately with a magnetic stirrer, 50 g of octoxynol is added and stirred until the octoxynol is completely dissolved. Then, under the same stirring conditions over a period of 30 minutes, 70 g of cyanoacrylic acid butyl ester is added in drops, and the solution is stirred for another 6 hours so that no air is introduced. After the polymerization is completed, the primary dispersion is filtered to separate larger polymer particles.

b) Production of Gas-Filled Microcapsules

The filtered primary dispersion is transferred into a steel loop reactor and gassed with argon for 24 hours at a volumetric rate of flow of 5 l/h with a sintered filter that is made of Teflon (surface area =100 cm²) with a pore width of 1 μm while being stirred. In this case, the necessary circulation for the cycle operation in the loop reactor is carried out by a suitable stirring element. The floated material is separated from the reaction medium and taken up with 1000 ml of water for injection purposes.

### EXAMPLE 11

Comparison Test: Undefined External Gassing/Defined External Gassing

A. Defined External Gassing

a) Production of Nanoparticles (Primary Dispersion)

1. 5 l of a 0.2% (m/m) octoxynol solution in water (MilliQ) with a pH of 2.2 (adjusted with 1N hydrochloric acid) is tempered to 5 C. (ice bath). 250.4 g of cyanoacrylic acid butyl ester (Sicher Company Batch=#49051833) is added in drops over 120 minutes via a spray pump (Precidor type, Infors AG Company, Basel). In this case, the solution is stirred with a magnetic stirrer of the IKA Company (type=Midi Mir 1) at 150-200 rpm (teflor-coated rod stirrer 70 mm).

Then, it is stirred for 30 more minutes, and the octoxynol content is adjusted to 1% (m/m). After another 15 minutes of stirring, the ice bath is removed and stirred for another 22 hours, whereby the temperature of the dispersion increases to room temperature.

After the polymerization is completed, the primary dispersion is filtered through a pleated filter (Schleicher 0905 ½) to separate larger polymer particles. The filter is dried at 50° C. The weight of the residue of polymer (loss) is 75 g (about 30% (m/m) relative to the cyanoacrylic acid butyl ester that is used.

A primary dispersion with a particle diameter of 161.2 nm is obtained (16.4% standard deviation; measuring device NICOMP Submicron Particle Sizer Model 370, Manufacturer Particle Sizing Systems).

b) Production of Gas-Filled Microcapsules

1430 g of the primary dispersion according to 11 A a) is diluted three times with 3570 g each of 1% (m/m) octoxynol solution in water (MilliQ). The primary dispersion that is obtained in each case has a content of 1% (m/m) polybutylcyanoacrylic acid ester and 1% (m/m) octoxynol.

The primary dispersion is gassed in a 10 1 glass flask with a sintered filter of a nominal pore size of 0.5 μm for 12 hours (Pall PSS high-grade steel filter purchase code MCS 4469 P05). The flow of compressed air is 25-30 l/h (float-type flowmeter) at a stirring speed of 150-200 rpm with a vane stirrer (10 cm vane).

Then, the microcapsule dispersion is transferred into a spherical separating funnel, the liquid subnatant is drawn off after 24 hours, and the floated material is taken up with 500 ml of 0.1% (m/m) octoxynol solution. The process is repeated twice. 100 ml of this 500 ml is again floated and taken up in 100 ml of 0.05% (m/m) octoxynol solution.

A microcapsule dispersion that is washed three times with a numerically weighted particle diameter of 2.32 μm and a volume-weighted particle diameter of 3.32 μm is obtained (32% or 38% standard deviation). The microcapsule concentration is about 9×10⁵/μl (microcapsules >0.4 μm). Particle size and number were measured with the measuring device Accusizer Model CW 770 of the Manufacturer Particle Sizing Systems.

B. Undefined External Gassing

a) Production of Nanoparticles (Primary Dispersion)

7 l of a 1% (m/m) octoxynol solution in water (MilliQ) with a pH of 2.2 (adjusted with 1N hydrochloric acid) is tempered to 5° C. (ice bath). 100 g of cyanoacrylic acid butyl ester is added in drops over a period of 2 minutes (1.4% (m/m)).

In this case, the solution is stirred with a magnetic stirrer of the IKA Company (type=Midi Mir 1) at 150-200 rpm (teflor-coated rod stirrer 70 mm).

Then, it is stirred for 30 more minutes, the ice bath is removed, and it is stirred for another 22 hours, whereby the temperature of the dispersion increases to room temperature.

After the polymerization is completed, the primary dispersion is filtered through a 48 μm nylon filter to separate larger polymer particles. The filter is dried at 50° C. The weight of the residue of polymer (loss) was less than 10 g (<10% (m/m) relative to the cyanoacrylic acid butyl ester that is used.

Five primary dispersions are thus produced.

The particle diameter value of the five primary dispersions is 37 nm (14% standard deviation; (measuring device NICOMP Submicron Particle Sizer Model 370, Manufacturer Particle Sizing Systems).

a) Production of Gas-Filled Microcapsules

In each case, 6 l of the five primary dispersions produced according to 11 B a) is transferred into a 20 l reactor with a dispersing unit (reactor: reactron type; Kinematica Company (Switzerland)). At the bottom, the reactor has a discharge through which the primary dispersion is taken in by a rotor-stator unit at an operating speed of 6000 rpm (dispersing tools three times fine) and fed back into the reactor via the top. 20 l/h (measured with a thermal gas flowmeter) of nitrogen is introduced into the dispersing tool via a capillary (ID about 1 mm).

The dispersion is run in the circuit for 180 minutes.

Five microcapsule dispersions are obtained to which on average a numerically weighted particle diameter of 1.14 μm and a volume-weighted particle diameter of 1.83 μm are imparted (16% or 13% standard deviation: measuring device Accusizer Model CW 770 Manufacturer Particle Sizing Systems).

Then, the five microcapsule dispersions in each case are transferred into a 10 l glass separating funnel and floated for at least 7 days to at most 14 days.

The subnatants of all five floated materials are drained, the floated materials in each case are taken up with 1.5 kg (0.05% (m/m) of octoxynol solution, thoroughly mixed for 60 minutes with a 70 mm propeller stirrer, and all five floated materials that are taken up are combined in a 20 l separating funnel. After five days of service life, the liquid subnatant is drained off again, and the floated material is taken up with 10 kg of 0.05% (m/m) of octoxynol solution and stirred for 60 minutes with a 70 mm propeller stirrer at 400 rpm. This is repeated twice.

A microcapsule dispersion that is washed three times with a numerically weighted particle diameter of 1.38 μm and a volume-weighted particle diameter of 2.27 μm is obtained (35.1% or 46.8% standard deviation). The microcapsule concentration is about 8.2×10⁶/μl (microcapsules >0.4 μm). Particle size and number were measured with the measuring device Accusizer Model CW 770 of the Manufacturer Particle Sizing Systems.

C) Spectral Doppler Study

Gas-filled microcapsules produced according to Example 11 A b) and Example 11 B b) are studied and compared with respect to their contrast-enhancing properties on an anesthetized dog (n=2, 8.5 kg and 11.9 kg, male). For the initiation of anesthesia, the dogs receive subcutaneously a mixture that consists of 0.1 ml of Rompun^{(R)}/kg of body weight (=2 mg of xylazine) and 0.2 ml of I-polamivet ^{(R)}/kg of body weight (=0.5 mg of levomethadone hydrochloride and 0.025 mg of fenpipramide hydrochloride). The sedated dogs are then intubated and put under inhalation anesthesia with 1.5-3.0% enflurane in 23% O₂ (nitrogen radical). Each dog is placed on its right side lying on a constant-temperature examination table. Then, a venous access (indwelling venous catheter, Insyte^{(R)}, Becton Dickinson) is run into the cephalic vein. A three-way cock is mounted thereon, via whose lateral access the indwelling venous catheter is flushed in each case with 5 ml of isotonic common salt solution after each contrast medium injection. As a result, it is ensured that the desired amount of contrast media is completely administered.

The inside of the right leg is shaved in the area of the femoral artery, and remaining hair is removed with a depilatory cream (Pilca^{(R))}. With the aid of a joint clamp that is fastened to the examination table, a linear scanner (L 10-5) of the ATL-HDI UM9 ultrasonic diagnostic device is positioned in lengthwise direction perpendicular to the femoral artery in such a way that the latter can be seen in a longitudinal section in a 2-dimensional ultrasonic image.

The measuring of signal amplitude and signal amplification after contrast medium injection is carried out in spectral Doppler mode. To this end, the audio signal that is generated in the ultrasonic device is digitalized for online study by means of an A/D-converter card (Megabyte Cooperation). Software that is programmed for this study (Schering) represents the realtime signal plot continuously on a computer monitor and in addition calculates the relevant parameters (intensity-units (IU) as well as enhancement (dB) over the period(s)) in each injection.

The gas-filled microcapsules produced according to Example 11 A b) and Example 11 B b) are administered intravenously to each dog at a dose of 1×10⁷ MK/kg of body weight (n=2). After each injection, the measuring is automatically completed if an enhancement value of 6 dB is again reached.

The maximum of the contrast enhancement (dB), the surface area under the intensity-time curve (AUC in IU×s) and the enhancement period (s) over 6 dB relative to precontrast are calculated for each injection (Table 1).

TABLE 1
Result of the Spectral Doppler Intensitometry

| | | Maximum | AUC > 6 dB | Enhancement |
|---|---|---|---|---|
| Example | Dose | (dB) | (IU × s) | period (s) |
| 11 A b) | 1 × 10⁷ of | 28.9 ± 1.6 | 1825 ± 238 | 21.5 ± 15 |
| | MK/kg of | | | |
| | body weight | | | |
| 11 B b) | 1 × 10⁷ of | 32.6 ± 0.9 | 8078 ± 963 | 1162 ± 57 |
| | MK/kg of | | | |
| | body weight | | | |

FIG. 1 shows the curve plot of the intensity-time curve and the amplification period.

It can be seen clearly that the gas-filled microcapsules with defined external gassing (Example 11 A b)) make possible a clearly higher and longer Doppler amplification than the microcapsules that were produced under undefined external gassing (Example 11 B b)).

D. Determination of the Acoustic Distribution Width in the Dog-Kidney Model

For the initiation of anesthesia, six beagles (dog 1: f, 9.2 kg; dog 2: f, 14.0 kg; dog 3: f, 9.4 kg; dog 4: f, 9.6 kg; dog 5: m, 15.6 kg,; dog 6: m, 9.5 kg) receive subcutaneously a mixture that consists of 0.1 ml of Rompun^{(R)}/kg of body weight (=2 mg of xylazine) and 0.2 ml of 1-Polamivet^{(R)}/kg of body weight (=0.5 mg of levomethadone hydrochloride and 0.025 mg of fenpipramide hydrochloride). The sedated dogs are then intubated and put under inhalation anesthesia with 1.5-3.0% enflurane in 23% O₂ (nitrogen radical).

Each dog is placed on its right side lying on a constant-temperature examination table. The lateral region of the left kidney is shaved, and the remaining hair is removed with a depilatory cream (Pilca^{(R)}). On the lateral side of the left kidney, a Curved-Array Scanner C5-2 is positioned and set so that a longitudinal sectional image of the left kidney is obtained. The study is performed with an HDl 5000 ultrasonic device in color Doppler mode (sonic pressure: mechanical index MI: 1.1/1.2 and MI: 0.53).

An indwelling venous cannula (18G, INSYTE^{(R)}) is inserted into the cephalic vein of the left leg and fastened with adhesive strips.

The microcapsule dispersions were infused with a MEDRAD PULSAR™ injector system with the aid of a 30 ml QWIK-FIT one-way syringe of the Medrad Company. To fill the syringe, the syringe is held upright, and the vial is turned over and placed on the cannula of the syringe. After the microcapsule dispersion is drawn off, the syringe is rotated vertically downward by 180°. Various infusion speeds are used (microcapsules/kg of body weight/min). The number of SAE signals is determined in which first a low sonic pressure amplitude (MI: 0.53) and then a higher sonic pressure amplitude (MI: 1.1/1.2) are used for excitation.

Both microcapsule dispersions are tested in three different dogs in each case under two sonic pressures (MI: 1.1/1.2 and MI: 0.53). The lowest dose depends on the beginning of the occurrence of the first SAE signals in the kidney. The dose amount is limited by the concentration of SAE signals in the kidney, which still allows the discrimination of individual signals.

To characterize both microcapsule dispersions in the case of high sonic pressure (MI: 1.1/1.2), the values of 60 identified SAE signals (Y-axis, FIG. 2) are taken as the baseline in the kidney. Starting from this value, the dose that is required for this purpose is plotted on the X-axis (for example, see FIG. 2).

Below, the number of SAE signals in the low sonic pressure (MI: 0.53) that can actually be detected in this dose is determined.

Then, the loss of detected SAE signals from the high sonic pressure to the low sonic pressure was determined at the same dose for each substance within each dog. The smaller this loss turns out to be, the narrower the range is in which the microcapsules can be excited to form SAE signals.

TABLE 2
Color Doppler Study in the Dog Kidney

| | | | | | To detect |
|---|---|---|---|---|---|
| | | | | | required |
| | | Number of | | Loss of | microcapsule |
| | | detected SAE | | detected | concentration |
| | | signals | | SAE | over 60 SAE |
| | Number | MI: | | signals in | signals |
| Example | of dog | 1.1/1.2 | MI: 0.53 | % | [T/kg/min] |
| 11 A b) | Dog 1 | 60 | 6 | 90 | 3.2 × 10⁵ |
| | Dog 2 | 60 | 20 | 66 | 1.6 × 10⁵ |
| | Dog 3 | 60 | 25 | 58 | 1 × 10⁶ |
| | | | | x = 71 ± 17 | x = 4.9 × 10⁵ |
| 11 B b) | Dog 4 | 60 | 34 | 43 | 1.8 × 10⁴ |
| | Dog 5 | 60 | 39 | 35 | 2.4 × 10⁴ |
| | Dog 6 | 60 | 37 | 38 | 3.4 × 10⁴ |
| | | | | x = 39 ± 4 | x = 2.5 × 10⁴ |

The results in Tab. 2 show that the gas-filled microcapsules according to Example 11 A b) (defined external gassing) have a significantly smaller loss of SAE signals from the high sonic pressure to the low sonic pressure at the same dose than gas-filled microcapsules according to Example 11 B b) (undefined external gassing). Moreover, the gas-filled microcapsules according to claim 11 A b) (defined external gassing) already show 60 SAE signals at a high sonic pressure at generally a 10-fold smaller dose than gas-filled microcapsules according to Example 11 B b) (undefined external gassing). The destruction threshold within the population is considerably more narrowly distributed.

FIG. 2 graphically compares the results from one dog in each case.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Multi-stage process for the production of gas-filled microcapsules, in which in one process step, polymerization of the shell-shaping substance(s) takes place, and in a process step that is separated from it in space and/or time, the formation of the microcapsules by a build-up process takes place in each case while being stirred, characterized in that the build-up of microcapsules is carried out under defined external gassing.

2. Process according to claim 1, wherein the defined external gassing is carried out by means of a sintered filter of a defined pore size.

3. Process according to claim 2, wherein the sintered filter consists of metal, plastic, glass or ceramic.

4. Process according to claim 3, wherein the sintered filter consists of steel or Teflon.

5. Process according to one of claims 1 to 4, wherein the sintered filter has a pore size of 0.05 μm to 1000 μm.

6. Process according to claim 5, wherein an especially suitable sintered filter has a pore size of 0.1 to 100 μm and in particular of 0.25 to 25 μm.

7. Process according to one of claims 1 to 6, wherein the polymerization of the shell-shaping substance(s) and/or the build-up of microcapsules is performed in a discontinuous, semi-continuous or continuous stirring vessel with a diameter to height ratio of 0.3 to 2.5.

8. Process according to one of claims 1 to 7, wherein the polymerization of the shell-shaping substance(s) and/or the build-up of microcapsules is performed in a discontinuous, semi-continuous or continuous stirring vessel in a diameter to height ratio of 0.3 to 2.5 with an outside loop (loop reactor).

9. Process according to one of claims 1 to 8, wherein the polymerization of the shell-shaping substance(s) and/or the build-up of microcapsules is performed with a vertical, oblique or lateral stirring element, whose diameter in the ratio to the reactor diameter is in a range of 0.2 to 0.7.

10. Process according to one of claims 1 to 9, wherein one or more of the following monomers is used: lactides, alkyl esters of acrylic acid, alkyl esters of methacrylic acid, and preferably alkyl esters of cyanoacrylic acid.

11. Process according to claims 1 to 10, wherein one or more of the following monomers are used: butyl, ethyl and isopropylcyanoacrylic acid.

12. Process according to one of claims 1 to 11, wherein the monomer or monomers are added at a concentration of 0.1 to 60%, preferably 0.1 to 10%, to the acidic aqueous solution.

13. Process according to claims 1 to 12, wherein one or more of the following surfactants are used:
Alkylarylpoly(oxyethylene)sulfate alkali salts, dextrans, poly(oxyethylenes), poly(oxypropylene)-poly(oxyethylene)-block polymers, ethoxylated fatty alcohols (cetomacrogols), ethoxylated fatty acids, alkylphenolpoly(oxyethylenes), copolymers of alkylphenolpoly(oxyethylene)s and aldehydes, partial fatty acid esters of sorbitan, partial fatty acid esters of poly(oxyethylene)sorbitan, fatty acid esters of poly(oxyethylene), fatty alcohol ethers of poly(oxyethylene), fatty acid esters of saccharose or macrogol glycerol esters, polyvinyl alcohols, poly(oxyethylene)-hydroxy fatty acid esters, macrogols of multivalent alcohols, partial fatty acid esters.

14. Process according to one of claims 1 to 13, wherein one or more of the following surfactants are used:
Ethoxylated nonylphenols, ethoxylated octylphenols, copolymers of aldehydes and octylphenolpoly(oxyethylene), ethoxylated glycerol-partial fatty acid esters, ethoxylated hydrogenated castor oil, poly(oxyethylene)-hydroxystearate, poly(oxypropylene)-poly(oxyethylene)-block polymers with a molar mass of <20,000.

15. Process according to one of claims 1 to 14, wherein one or more of the following surfactants are used:
Para-octylphenol-poly-(oxyethylene) with 9-10 ethoxy groups on average (=octoxynol 9,10), para-nonylphenol-poly(oxyethylene) with 30/40 ethoxy groups on average (=e.g., Emulan^{(R)}30/Emulan^{(R)}40), para-nonylphenol-poly(oxyethylene)-sulfate-Na salt with 28 ethoxy groups on average (=e.g., Disponil^{(R)} AES), poly(oxyethylene)glycerol monostearate (=e.g., Tagat^{(R)} S), polyvinyl alcohol with a degree of polymerization of 600-700 and a degree of hydrolysis of 85%-90% (=e.g., Mowiol^{(R)}4-88), poly(oxyethylene)-660-hydroxystearic acid ester (=e.g., Solutol^{(R)} HS 15), copolymer of formaldehyde and para-octylphenolpoly(oxyethylene) (=e.g., Triton^{(R)} WR 1339), polyoxypropylene-polyoxyethylene-block polymers with a molar mass of about 12,000 and a polyoxyethylene proportion of about 70% (=e.g., Lutrol^{(R)} F127), ethoxylated cetylstearyl alcohol (=e.g., Cremophor^{(R)} A25), ethoxylated castor oil (=e.g., Cremophor^{(R)} EL).

16. Process according to one of claims 1 to 15, wherein the surfactant or surfactants are used at a concentration of 0.1 to 10%.

17. Process according to one of claims 1 to 16, wherein at least one of the process steps is carried out in acidic aqueous solution.

18. Process according to one of claims 1 to 17, wherein the following acids are used: hydrochloric acid, phosphoric acid and/or sulfuric acid.

19. Process according to one of claims 1 to 18, wherein the polymerization and the build-up of microcapsules are carried out at temperatures of −10° C. to 60° C.

20. Process according to one of claims 1 to 19, wherein the gas-filled microcapsules are separated from the reaction medium by flotation, taken up in a physiologically compatible medium and optionally freeze-dried after the addition of a cryoprotector.

21 Process according to one of claims 1 to 20, wherein to take up the floated material, water or 0.9% common salt solution is used as a physiologically compatible medium.

22. Process according to one of claims 1 to 21, wherein polyvinylpyrrolidone, polyvinyl alcohol, gelatin and/or human serum albumin is used as a cryoprotector.

23. Gas-filled microcapsules that can be obtained according to a process of one of claims 1 to 22.
